(19) United States
(12) Patent Application Publication
(10) Pub. No.: US 2026/0250485 A1
(43) Pub. Date: Aug. 27, 2026

(54) LYCOPENE AS A DRY OXYGEN SCAVENGER FOR ACTIVE PACKAGING APPLICATIONS

(71) Applicant: CSP Technologies, Inc., Auburn, AL (US)

(72) Inventors: Vincent Hembrick-Holloman, Auburn, AL (US); Jason Pratt, Auburn, AL (US)

(21) Appl. No.: 19/545,717

(22) Filed: Feb. 20, 2026

Related U.S. Application Data
(60) Provisional application No. 63/762,838, filed on Feb. 25, 2025.

(51) Int. Cl. C08K 5/01; B29C 48/00; B29K 23/00; B29K 105/00; B29L 31/00; B65D 75/32; B65D 81/26; C08J 3/20

(52) U.S. Cl. CPC C08K 5/01; B65D 75/322; B65D 81/267; C08J 3/201; B29C 48/0018; B29K 2023/00; B29K 2105/0005; B29L 2031/712; C08J 2323/04; C08J 2367/02

(57) ABSTRACT

An entrained polymer is provided that includes in a blended form, a base polymer and a conjugated olefin, optionally lycopene or a derivative thereof. The resulting entrained polymer is useful in the manufacture of packaging for the protection of oxygen-sensitive contents. Also provided are systems and methods for reducing contamination in a product due to oxidation. Also provided are related methods of manufacture and methods of use.

### CROSS-REFERENCE TO RELATED APPLICATIONS

The present application claims priority to U.S. Provisional Application No. 63/762,838, titled “LYCOPENE AS A DRY OXYGEN SCAVENGER FOR ACTIVE PACKAGING APPLICATIONS,” and filed Feb. 25, 2025, which is herein incorporated by reference in its entirety.

### FIELD OF THE INVENTION

Disclosed are entrained polymers comprising, in a blended form, a conjugated polyene, optionally lycopene or a derivative thereof, as an oxygen scavenging agent, and methods of their use to decrease oxygen concentrations and maintain properties of packaged oxygen sensitive products. The conjugated polyene scavenging agent is entrained in at least one base polymer with optional channels throughout. Also disclosed herein are related methods of preparation and methods of use.

### BACKGROUND

There are many items that are preferably stored, shipped and/or utilized in an environment that must be controlled and/or regulated. The control of moisture, oxygen, ethylene and other gaseous substances may be desirable in medical, diagnostic, industrial chemical, laboratory, electronics and food and drug packaging applications.

It is well known that regulating the exposure of oxygen-sensitive products to oxygen maintains and enhances the quality and stability or shelf life of the product. In packaging oxygen sensitive materials such as foodstuffs, herbs, beverages, pharmaceuticals, cosmetics, tobacco, cannabis, and others, oxygen contamination can be particularly troublesome. Electronic components and military products such as ammunition and other explosives may also be sensitive to atmospheric oxygen and require special packaging. Care in packaging oxygen-sensitive products is generally taken to reduce the detrimental or undesirable effects of oxygen on the product.

In the food and beverage packaging industry, many food products suffer oxygen-initiated degradation—for example, individual portions of prepared foods are marketed in containers made of plastics, and air entrapped therein, and leaking or transferring into the package after processing, is an acknowledged continuing industry problem. Limiting the exposure of oxygen sensitive food products to oxygen in a packaging system maintains the quality or freshness of the food, reduces spoilage, and extends the food's shelf life.

Numerous means for regulating oxygen exposure within packaging containers are used. In the 1960s, packaging containers were developed that envelop a product in an attempt to form a barrier within an oxygen-free package wherein free oxygen is ejected from the product and oxygen external to the package can be precluded. Such containers include modified atmosphere packaging (MAP) and oxygen barrier film packaging. Methods for excluding oxygen involving mechanical means also include vacuum and inert gas packaging. In these procedures, the oxygen is removed by displacement of the entire atmospheric mixture in the package by vacuumizing or flushing the oxygen from the container. In some instances, the package is backfilled with an inert gas. Such systems are used in boiler water treatment, the orange juice and brewing industries, and in modified-atmosphere packaging of food products. This technology, while somewhat equipment intensive, can remove about 90-95% of the oxygen present in air from the product (or its container) prior to or during packaging. However, the removal of the remaining 5-10% of oxygen using this approach requires longer times for vacuum treatment and increasingly larger volumes of higher and higher purity inert gas which must not itself be contaminated with trace concentrations of oxygen. This makes the removal by such methods of the last traces of oxygen expensive. A further disadvantage of these methods is a tendency to remove volatile product components. This is a particular problem with foods and beverages, wherein such components are often responsible for some or all of the aroma and flavor. These methods do not quantitatively remove all the oxygen from the package because complete evacuation is never achieved and oxygen often remains dissolved or trapped in the packaged product. In addition, when an inert gas backfill is used, the inert gas often brings traces of oxygen back into the package. Such vacuum or flushing methods, especially where inert gas handling is involved, often require machines of considerable cost and sophistication for high-speed packaging. It has proven extremely difficult to remove all traces of oxygen from packages of food products by mechanical means.

Another method used for regulating oxygen exposure is “active packaging”, whereby the package containing the food product has been modified in some manner to regulate the food's exposure to oxygen. This concept combines such systems as oxygen regulation (by oxygen scavengers), moisture regulators, carbon dioxide (CO₂) emitters, carbon dioxide (CO₂) absorbers, ethylene absorbers and many more.

Antioxidants (such as sulfur dioxide, trihydroxy butyrophenone, butylated hydroxy toluene and butylated hydroxy anisole) and oxygen scavengers (such as ascorbic acid, isoascorbic acid and glucose oxidase-catalase) have been used in an attempt to reduce the effects of oxygen contamination. The direct addition of such agents has several disadvantages. Both sulfur dioxide and ascorbates, (when added to beer, for example), can result in production of off-flavors thus negating the intended purpose of the addition.

Incorporating an oxygen scavenger into the packaging structure itself is another means to regulate exposure of a packaged product to oxygen.

Conventionally, desiccants, oxygen scavenging agents, and other active agents have been used in raw form, e.g., as loose particulates housed in sachets or canisters within packaging, to control the internal environment of the package. For many applications, it is not desired to have such loosely stored active substances. A more uniform scavenging effect through the package can be achieved by incorporating the scavenging agent in the package instead of adding a separate scavenger structure such as a sachet to the package. Uniformity may be especially important where there is restricted airflow inside the package. In addition, incorporating the oxygen scavenger into the package structure provides a means of intercepting and scavenging oxygen as it permeates the walls of the package, providing in effect an active oxygen barrier, thereby maintaining the lowest possible oxygen concentration in the package.

Limited success has been achieved in incorporating oxygen scavenging agent into the walls of packages for various types of foods. Previously developed scavengers include sulfite-based, ascorbate-based and enzyme-based systems as well as oxidizable polyamides and ethylenically unsaturated hydrocarbons. More recent scavengers include incorporation of natural products such as teas or carrots into polymer compositions.

Furthermore, technical challenges are experienced when processing powdery materials, such as oxygen scavengers, into polymer films or sheets, such as reduced transparency and deterioration of the mechanical properties of the film or sheet. Improved oxygen scavengers are desired in order to reduce such disadvantageous effects or challenges during manufacture.

To address these problems, active entrained polymers have been developed which comprise active agents. Such polymers can be extruded and/or molded into desired forms, e.g., container liners, plugs, film sheets, pellets and other such structures. Optionally, such active entrained polymers may include channeling agents, such as polyethylene glycol (PEG), which form channels between the surface of the entrained polymer and its interior to transmit a selected material (e.g., moisture) to the entrained active agent (e.g., desiccant to absorb the moisture).

Entrained polymers may be two phase formulations (i.e., comprising a base polymer and active agent, without a channeling agent) or three phase formulations (i.e., comprising a base polymer, active agent and channeling agent). Three phase entrained polymers and methods for making the same are described, for example, in U.S. Pat. Nos. 5,911,937, 6,080,350, 6,124,006, 6,130,263, 6,194,079, 6,214,255, 6,486,231, 7,005,459, and U.S. Pat. Pub. No. 2016/0039955, each of which is incorporated herein by reference as if fully set forth. These entrained polymers have been conventionally made as extruded products (e.g., pellets or films) or injection molded components (e.g., pucks, inserts or liners within containers).

There remains a need to provide film material with the capability of scavenging oxygen. Many uses can be envisioned for such material, including but not limited to inclusion into packaging for the protection of oxygen-sensitive contents.

### BRIEF SUMMARY

Accordingly, in one aspect is provided an entrained polymer comprising, in a blended form, a base polymer and lycopene, or a derivative thereof, optionally wherein the lycopene, or derivative thereof, is a granular or particulate material.

In some embodiments, the base polymer is chosen from a polyolefin, a polyamide, and a polyester. In some embodiments, the base polymer is a copolymer, such as, a block copolymer. In some embodiments, the block copolymer comprises a polyester segment and a polyether segment.

In some embodiments, the entrained polymer further comprises a channeling agent. In some embodiments, the channeling agent is chosen from a polyglycol, glycerin polyamine, polyurethane, and polycarboxylic acid, or any combination of the foregoing. In some embodiments, the channeling agent is a water insoluble polymer. In some embodiments, the channeling agent is chosen from polyethylene glycol (PEG), ethylene-vinyl alcohol (EVOH), polyvinyl alcohol (PVOH), propylene oxide polymerisate, propylene oxide polymerisate-monobutyl ether, ethylene vinyl acetate (EVA), nylon, nylon 6, nylon 66, or any combination of the foregoing.

In certain embodiments, the lycopene or derivative thereof is an oxidized derivative of lycopene.

In certain embodiments, the derivative of lycopene is an alcohol, aldehyde, or carboxylic acid derivative of lycopene.

In certain embodiments, the lycopene, or derivative thereof, comprises 5% to 50%, optionally 5% to 30%, optionally 5% to 25%, optionally 10% to 20%, optionally 12% to 16% by weight with respect to the total weight of the entrained polymer.

In certain embodiments, the lycopene, or derivative thereof, comprises about 15% by weight with respect to the total weight of the entrained polymer.

In certain embodiments, the lycopene, or derivative thereof, is provided in an extract from a plant. In certain embodiments, the plant is chosen from tomato, papaya, apricot, guava, fig, watermelon, red grapefruit, red carrot, pumpkin, red grape, red cabbage, red pepper, and pomegranate.

In certain embodiments, the lycopene is provided in a purity of at least 50%, or at least 60%, or at least 70%, or at least 80%, or at least 90% by weight.

In another aspect, there is provided a method for manufacturing the entrained polymer including the steps of: extruding a suitable precursor material comprising a molten mix of a polymer and lycopene, or a derivative thereof in a screw extruder with warming; passing the warmed extruded material through a tubular die; expanding and stretching the warmed extruded material with positive pressure; and allowing the expanded and stretched extruded material to cool.

In certain embodiments, the extruding includes a rotation speed of between 5 rpm and 35 rpm, inclusive, or between 10 rpm and 30 rpm, inclusive, or between 10 rpm and 25 rpm, inclusive, or between 10 rpm and 20 rpm, inclusive.

In certain embodiments, the extrusion is performed at a temperature between 140° C. and 180° C., inclusive, or 145° C. and 175° C., inclusive, or 150° C. and 170° C., inclusive, or 150° C. and 165° C., inclusive.

In certain embodiments, the method includes coextrusion of at least two layers for forming the expanded and stretched extruded material.

Also provided herein is a container which comprises an entrained polymer as disclosed herein and an interior space suitable for storage of a product.

Also provided herein is a method for minimizing or preventing oxidative decomposition of a product, the method comprising storing the product in a container as disclosed herein.

### BRIEF DESCRIPTION OF THE DRAWINGS

A full understanding of the disclosure can be gained from the following description of the preferred embodiments when read in conjunction with the accompanying drawings in which:

FIG. 1 is a perspective view of a plug formed of an entrained polymer that may be deposited onto a substrate according to methods of the disclosed concept;

FIG. 2 is a cross section taken along line 2-2 of FIG. 1;

FIG. 3 is a cross section similar to that of FIG. 2, showing a plug formed of another embodiment of an entrained polymer according to an optional embodiment of the disclosed concept;

FIG. 4 is a schematic illustration of an entrained polymer according to an optional embodiment of the disclosed concept, in which the active agent is lycopene, or a derivative thereof;

FIG. 5 is a cross-sectional view of a sheet or film formed of an entrained polymer according to an optional embodiment of the disclosed concept, adhered to a barrier sheet substrate;

FIG. 6 is a cross section of a package that may be formed using an entrained polymer according to an optional embodiment of the disclosed concept;

FIG. 7 depicts the effect of 5% lycopene powder on oxygen concentrations; horizontal axis=time (days), vertical axis=oxygen concentration, (i) 1 gram (ii) 2 grams (iii) 3 grams, according to an optional embodiment of the disclosed concept;

FIG. 8 depicts the effect of 10% lycopene powder on oxygen concentrations; horizontal axis=time (days), vertical axis=oxygen concentration, (i) 1 gram (ii) 2 grams (iii) 3 grams, according to an optional embodiment of the disclosed concept;

FIG. 9 depicts the effect of 96% lycopene powder on oxygen concentrations; horizontal axis=time (days), vertical axis=oxygen concentration, (i) 1 gram (ii) 2 grams (iii) 3 grams, according to an optional embodiment of the disclosed concept;

FIGS. 10(a) and 10(b) depict the effect of 96% lycopene powder on oxygen concentrations; FIG. 10(a) to 2.5 hour and FIG. 10(b) to 45 hour; horizontal axis=time (hours); vertical axis=oxygen concentration, (i) 1 gram (ii) 2 grams (iii) 3 grams, according to an optional embodiment of the disclosed concept;

FIG. 11 depicts the effect of 96% lycopene powder on oxygen concentrations; horizontal axis=time (days), vertical axis=oxygen concentration, (i) 0.25 grams (ii) 0.50 grams (iii) 0.75 grams, according to an optional embodiment of the disclosed concept; and

FIG. 12 depicts the effect of a film containing (i) 5% (ii) 10% (iii) 96% lycopene powder on oxygen concentrations; horizontal axis=time (days), vertical axis=oxygen concentration, according to an optional embodiment of the disclosed concept.

### DETAILED DESCRIPTION

In one aspect, there is provided herein an entrained polymer comprising, in a blended form, a base polymer and a conjugated polyene, optionally lycopene, or a derivative thereof.

In some embodiments, the conjugated polyene contains the —(CHR₁=CHR₂)ₙ— moiety, with each R₁ and R₂ independently chosen from H and CH₃, and with n chosen from 6, 7, 8, 9, 10, and 11.

In some embodiments, the conjugated polyene contains the moiety:

(CH₂=CH₂)—(CHCH₃=CH₂)—(CH₂=CH₂)—(CHCH₃=CH₂)—(CH₂=CH₂)—

In some embodiments, the conjugated polyene contains the moiety:

(CH₂=CH₂)—(CHCH₃=CH₂)ₘ—(CH₂=CH₂)—(CH₂=CHCH₃)ₙ—(CH₂=CH₂)—
wherein m and n are independently chosen from 1 and 2.

In some embodiments, the conjugated polyene contains the moiety:

(CH₂=CH₂)—(CHCH₃=CH₂)—(CH₂=CH₂)—(CH₂=CHCH₃)—(CH₂=CH₂)—

In some embodiments, the conjugated polyene is lycopene or a derivative thereof. In some embodiments, the lycopene or derivative thereof is an oxidized derivative of lycopene. In some embodiments, the oxidized derivative of lycopene is an alcohol, aldehyde, or carboxylic acid derivative of lycopene.

In some embodiments, the conjugated polyene is an ester or ether derivative of an alcohol derivative of lycopene and a carboxylic acid derivative of lycopene, respectively. In some embodiments, the conjugated polyene is a salt of a carboxylic acid derivative of lycopene.

In some embodiments, the conjugated polyene is a chain-shortened derivative of lycopene, including chain-shortened derivatives such as an apo-lycopenal as provided in Table 1.

TABLE 1
Lycopene and chain-shortened derivatives of lycopene thereof.

| | | |
|---|---|---|
| (a) | lycopene | 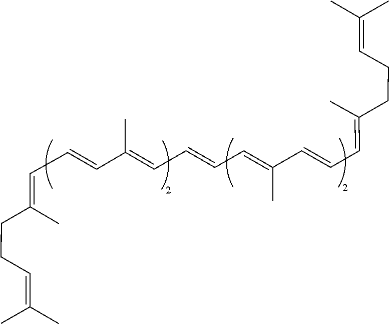 |
| (b) | apo-6′-lycopenal | 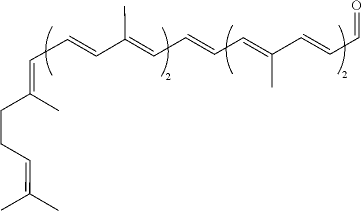 |
| (c) | apo-8′-lycopenal | 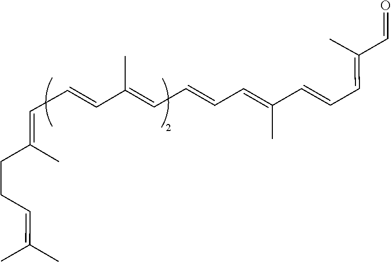 |
| (d) | apo-10′-lycopenal | 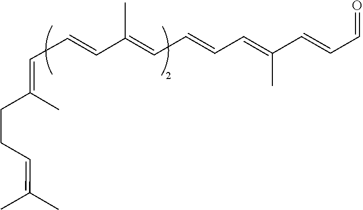 |

In some embodiments, the conjugated polyene is an apo-lycopenol or apo-lycopene carboxylic acid, in which the —CHO group is replaced with a —CH₂OH and —COOH, respectively.

In some embodiments, the conjugated polyene is a chain-shortened derivative of lycopene, including chain-shortened derivatives such as an apo-lycopenal as provided in Table 1, and the related apo-lycopenol and apo-lycopene carboxylic acid, in which the —CHO group is replaced with a —CH₂OH and —COOH, respectively.

In some embodiments, the conjugated polyene is an ester or ether derivative of an apo-lycopenol and apo-lycopene carboxylic acid, respectively. In some embodiments, the conjugated polyene is a salt of an apo-lycopene carboxylic acid.

In some embodiments, the lycopene, or derivative thereof, comprises from 5% to 50%, optionally from 5% to 30%, optionally from 5% to 25%, optionally from 10% to 20%, and optionally from 12% to 16% by weight with respect to the total weight of the entrained polymer.

In some embodiments, the lycopene, or derivative thereof, is provided in an extract from a plant. In some embodiments, the plant is chosen from tomato, papaya, apricot, guava, fig, watermelon, red grapefruit, red carrot, pumpkin, red grape, red cabbage, red pepper, and pomegranate.

In some embodiments, the entrained polymer further comprises a channeling agent. In some embodiments, the channeling agent is chosen from a polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid.

In some embodiments, the channeling agent is a water insoluble polymer, such as a propylene oxide polymerisate-monobutyl ether, such as Polyglykol B01/240, produced by CLARIANT. In some embodiments, the channeling agent is a propylene oxide polymerisate monobutyl ether, such as Polyglykol B01/20, produced by CLARIANT, propylene oxide polymerisate, such as Polyglykol D01/240, produced by CLARIANT, ethylene vinyl acetate (EVA), nylon 6, nylon 66, or any combination of the foregoing.

In some embodiments, the base polymer is chosen from a polyolefin, a polyamide, and a polyester. In some embodiments, the base polymer is chosen from a polyolefin and a polyester. In some embodiments, the base polymer is chosen from polyethylene, polypropylene, a polyethylene/polypropylene copolymer, and poly(lactic acid).

In some embodiments, the base polymer is a copolymer. In some embodiments, the base polymer is a polyolefin copolymer. In some embodiments, the base polymer is a copolymer with ethylene. In some embodiments, the base polymer is a copolymer with vinyl acetate. In some embodiments, the base polymer is poly(ethylene-vinyl acetate), also known as ethylene-vinyl acetate or EVA.

In some embodiments, the base polymer is a thermoplastic. In some embodiments, the base polymer is a thermoplastic elastomer. In some embodiments, thermoplastic elastomer is a thermoplastic polyamide elastomer. In some embodiments, thermoplastic elastomer is a thermoplastic polyester elastomer. In some embodiments, thermoplastic elastomer is a thermoplastic polyolefin elastomer. In some embodiments, thermoplastic elastomer is a thermoplastic polystyrene elastomer. In some embodiments, thermoplastic elastomer is a thermoplastic polyurethane elastomer. In some embodiments, thermoplastic elastomer is a thermoplastic elastomer vulcanizate. In some embodiments, thermoplastic elastomer is an unclassified thermoplastic polyamide elastomer. In some embodiments, thermoplastic elastomer is a block copolymer.

Suitable base polymers include thermoplastic polymers, including but not limited to polypropylene, polyethylene, polyisoprene, polyhydroxyalkanoates (PHAs), polylactic acid (PLA), polybutylene succinate (PBS), polyhexene, polybutadiene, polybutene, polysiloxane, polycarbonate, polyamide, ethyl vinyl acetate, ethylene-vinyl acetate (EVA) copolymer, ethylene-methacrylate copolymer, polyvinyl chloride (PVC), polystyrene, polyester, polyanhydride, polyacrylonitrile, polysulfone, polyacrylic ester, acrylic, polyurethane, polyacetal, polyvinylpyrrolidone (PVP), a copolymer, and combinations thereof.

In some embodiments, the base polymer is a block copolymer. In some embodiments, the block copolymer comprises a polyester segment and a polyether segment. In some embodiments, the polyester segment is poly(alkylene terephthalate). In some embodiments, the polyester segment is poly(butylene terephthalate). In some embodiments, the polyether segment is a poly(alkylene glycol). In some embodiments, the polyether segment is chosen from polyethylene glycol, polypropylene glycol, and polytetramethylene glycol. In some embodiments, the polyether segment is one or more long chain glycols. In some embodiments, the block co-polymer includes a hard crystalline segment and a soft amorphous segment. In some embodiments, the block co-polymer exhibits high thermal stability.

Also provided herein is a container which comprises an entrained polymer as disclosed herein and an interior space suitable for storage of a product. In some embodiments, the container comprises at least one article, comprising an entrained polymer as disclosed herein, located within the interior space. In some embodiments, inclusion of the product within the container creates a headspace formed by the interior space that is not occupied by the product. In some embodiments, the container comprises a bottom surface, a top opening, and one or more sidewalls extending in a vertical direction from the bottom surface to the top opening. In some embodiments, the container further comprises a cover to close and/or seal the container.

Also provided herein is a method for minimizing or preventing oxidative decomposition of a product, the method comprising storing the product in a container as disclosed herein.

Also provided are embodiments wherein any embodiment above may be combined with any one or more of these embodiments, provided the combination is not mutually exclusive.

As used herein, two embodiments are “mutually exclusive” when one is defined to be something which is different than the other. For example, an embodiment wherein two groups combine to form a cycloalkyl is mutually exclusive with an embodiment in which one group is ethyl the other group is hydrogen. Similarly, an embodiment wherein one group is CH₂ is mutually exclusive with an embodiment wherein the same group is NH.

In some embodiments of any of the compositions or methods described herein, a range is intended to comprise every integer or fraction or value within the range.

Embodiments described herein as “comprising” one or more features may also be considered as disclosure of the corresponding embodiments “consisting of” and/or “consisting essentially of” such features.

### Definitions

Unless clearly indicated otherwise, the terms “a” and “an” herein do not denote a limitation of quantity, but rather denote the presence of at least one of the referenced item.

As used herein, the term “between” when used in mathematical expressions, is understood to include both endpoints. By way of example, the expression “an integer between 1 and 5” is understood to consist of the set 1, 2, 3, 4, and 5.

As used herein, the term “active” is defined as capable of acting on, interacting with or reacting with a selected material (e.g., moisture or oxygen) according to the disclosure. Examples of such actions or interactions may include absorption, adsorption or release of the selected material.

As used herein, the term “active agent” is defined as a material that (1) is immiscible with the base polymer, and when mixed and heated with the base polymer or the base polymer and the channeling agent, will not melt, i.e., has a melting point that is higher than the melting point for either the base polymer or the channeling agent, and (2) acts on, interacts or reacts with a selected material. The term “active agent” may include but is not limited to materials that absorb, adsorb or release the selected material(s). Active agents according to the disclosure may be in the form of grains or particles, but the disclosure should generally not be viewed as limited only to granular or particulate active agents (unless a respective claim recites otherwise).

Active agents in the compositions disclosed herein include, but are not limited to, oxygen scavenging agents. The oxygen scavenging agents in the compositions disclosed herein include, but are not limited to, conjugated polyenes, including lycopene and derivatives thereof.

The term“acyl”, as used herein, refers to a group having the formular RC(═O)—, wherein R is alkyl or aryl.

The term “alkyl”, as used herein, refers to a saturated, singly unsaturated, or multiply unsaturated linear hydrocarbon group. Unless otherwise indicated, the term embraces all possible stereo- and regioisomers. In some embodiments, an alkyl group has the formula CₘH₍₂ₘ₊₁₎, with m between 1 and 16, inclusive, optionally between 1 and 14, inclusive, optionally between 1 and 12, inclusive, optionally between 1 and 10, inclusive, optionally between 1 and 8, inclusive, optionally between 1 and 6, inclusive, optionally between 1 and 4, inclusive. In some embodiments, an alkyl group is chosen from —CH₃ and —(CH₂)ₘCH₃, with m between 1 and 16, inclusive, optionally between 1 and 14, inclusive, optionally between 1 and 12, inclusive, optionally between 1 and 10, inclusive, optionally between 1 and 8, inclusive, optionally between 1 and 6, inclusive, optionally between 1 and 4, inclusive. In some embodiments, the alkyl group is chosen from —CH₃ and —CH₂CH₃. In some embodiments, the alkyl group is —CH₃. The alkyl group may be specified by indicating the number of carbons. By way of example, C₁₋₁₀alkyl refers to an alkyl group with between 1 and 10 carbon atoms, inclusive.

The term “aryl”, as used herein, refers to a mono- or polycyclic hydrocarbon group wherein each cycle (ring) is aromatic. Unless otherwise indicated, the term embraces all possible regioisomers. Exemplary aryl groups include phenyl, and naphthyl.

The term “carboxy”, as used herein, refers to —COOH.

The term “cycloalkyl”, as used herein, refers to a saturated, singly unsaturated, or multiple unsaturated mono- or polycyclic hydrocarbon group, wherein at least one cycle (ring) is nonaromatic. Exemplary cycloalkyl groups include cyclopentyl, cyclohexyl, and decahydronaphthyl. Unless otherwise indicated, the term embraces all possible stereo- and regioisomers.

The term “heterocycloalkyl”, as used herein, refers to a saturated, singly unsaturated, or multiple unsaturated mono- or polycyclic group containing at least one heteroatom, wherein at least one cycle (ring) is nonaromatic. In some embodiments, the heteroatom is chosen from N, 0, and S. Unless otherwise indicated, the term embraces all possible stereo- and regioisomers. Exemplary cycloalkyl groups include pyrrolidinyl, pyranyl, and tetrahydrofuranyl.

The term “heteroaryl”, as used herein, refers to a mono- or polycyclic group containing at least one heteroatom, wherein each cycle (ring) is aromatic. In some embodiments, the heteroatom is chosen from N, O, and S. Unless otherwise indicated, the term embraces all possible regioisomers. Exemplary heteroaryl groups include furyl, pyridyl, and thienyl.

The term “carbonyl”, as defined herein, refers to the —C(═O) fragment. The term “oxo”, as defined herein, refers to ═O, i.e. an oxygen double bonded to a single atom.

The term “cyano”, as defined herein, refers to —CN.

The term “hydroxy”, as defined herein, refers to —OH. The term “oxy” refers to the —O— fragment.

Groups containing multiple terms are defined by the identity of individual terms, read right to left. By way of example, “arylalkyl” refers to the group R¹R²—, wherein R¹ is aryl, and R² is alkyl. By way of example, “alkyloxy” (often referred to as “alkoxy”) refers to the group R—O—, wherein R is alkyl.

As used herein, a substituted alkyl group refers to an alkyl group in which one or more hydrogens of the alkyl group is substituted with groups X, each individually chosen unless specified otherwise. In some embodiments, X is chosen from halo, cyano, hydroxy, oxo, acyl, acyloxy, alkyl, alkoxy, aryl, aryloxy, cycloalkyl, cycloalkyloxy, heterocycloalkyl, heterocycloalkyloxy, heteroaryl, and heteroaryloxy, with each of these terms as defined herein. In some embodiments, X is chosen from halo, cyano, hydroxy, oxo, acyl, alkyl, aryl, cycloalkyl, heterocycloalkyl, and heteroaryl, with each of these terms as defined herein. In some embodiments, X is chosen from halo, cyano, hydroxy, and oxo, with each of these terms as defined herein.

As used herein, the term “polyene” refers to a compound containing two or more double bonds. Examples include butadiene (CH₂=CH—CH═CH₂), 2-methyl-1,3-butadiene (isoprene, CH₂=C(CH₃)—CH═CH₂), 1,3-pentadiene (piperylene, CH₂=CH—CH═CH(CH₃)), and 1,4-pentadiene (CH₂=CH—CH₂—CH═CH₂).

As used herein, the term “conjugated polyene” refers to a compound containing two or more double bonds, at least two of which are in conjugation. Examples include butadiene (CH₂=CH—CH═CH₂), 2-methyl-1,3-butadiene (isoprene, CH₂=C(CH₃)—CH═CH₂), and 1,3-pentadiene (piperylene, CH₂=CH—CH═CH(CH₃)).

As used herein, the term “polymer” refers to a compound composed of a linear chain of monomers. A polymer can be further defined as a “hompolymer”, which is composed of identical monomers, and may be represented as (-A-)ₙ, with integer subscript n indicating the degree of polymerization.

Degree of polymerization is often provided as subscript n to a monomer A, giving (-A-)ₙ or a similar expression. It will be understood that the number of monomers for individual molecules in a quantity of polymeric material can deviate from the degree of polymerization. In general, integer subscript n, termed the degree of polymerization, is without limit, and represents the average number of monomers in each polymer molecule in a polymer material. It will further be understood that the expression (—X—)ₙ is frequently used in the art to represent a polymeric material, and the absence of an accompanying numeric value or range for n in a particular expression should be construed as having a degree of polymerization without limit. In some embodiments, n is below 5000, optionally below 2000, optionally below 1000, optionally below 500, optionally below 200, optionally below 100, optionally below 50. In some embodiments, the degree of polymerization is greater than 50, optionally greater than 100, optionally greater than 200, optionally greater than 500, optionally greater than 1000. In some embodiments, n is between 50 and 5000, inclusive, optionally between 100 and 2500, inclusive, optionally between 200 and 2000, inclusive, optionally between 500 and 1500, inclusive. In some embodiments, the degree of polymerization is between 100 and 5000, inclusive. In some embodiments, the degree of polymerization is between 200 and 2000, inclusive. In some embodiments, the degree of polymerization is between 500 and 5000, inclusive.

A polymer can be further defined as a “copolymer”, which is composed of two or more types of monomers, for example “A” and “B”. The term “copolymer” can further be subdivided into “random copolymers”, for which no regular pattern exists for occurrence of either “A” or “B” in a polymer chain, “alternating copolymers”, which may be represented as -A-B-A-B- etc., and “block copolymers”, which consist of contiguous sequences of monomers interspersed with each other, e.g. -A-A-A-B-B-B-A-A-A- etc. In general, the number of each type of monomer in contiguous sequences of the monomer is without limit, and the number need not be uniform in either the quantity of polymer or in an individual strand. Unless otherwise indicated, the degree of polymerization n for a copolymer represents the average number of monomers, of all types, in each polymer molecule in a polymer material.

As used herein, the term “polyolefin” refers to a polymer with formula (—CH₂CHR—)ₙ, with R chosen from H, alkyl, chloro, aryl, hydroxy, acyloxy, acetoxy, carboxy, and alkoxycarbonyl. In some embodiments, R is chosen from H, alkyl, and phenyl. In some embodiments, R is chosen from H and C₁₋₁₀alkyl. In some embodiments, R is chosen from H and CH₃. In some embodiments, the polyolefin is chosen from polyethylene, low-density polyethylene (“LDPE”), linear low-density polyethylene (LLDPE), very-low-density polyethylene (VLDPE), ultra-low-density polyethylene (ULDPE), and medium-density polyethylene (MDPE).

As used herein, the term “polyester” refers to a polymer with formula (—X—COO—)ₙ, with X being a bivalent organic moiety. In some embodiments, the polyester has the formula (—CHRCOO—)ₙ, with R chosen from H and C₁₋₁₀alkyl. In some embodiments, the polyester has the formula ((—CH₂)ₘCOO—)ₙ, wherein m is chosen from 1, 2, 3, 4, and 5. In some embodiments, the polyester has the formula (—OOC—Y—COO—Z)ₙ, with Y and Z both being bivalent organic moieties. In some embodiments, Y=1,4-phenylene. In some embodiments, Z is chosen from ethylene, butylene (tetramethylene), hexylene (hexamethylene), and 1,4-cyclohexenedimethylene. In some embodiments, the polyester is polyethylene terephthalate (“PET”). In some embodiments, the polyester is poly-1, 4-cyclohexylene-dimethylene terephthalate (“PCDT”).

As used herein, the term “oxygen scavenging agent” is defined as an active agent that can decrease the amount of oxygen in a gaseous environment. An oxygen scavenging agent can act by any mechanism, including but not limited to chemical reduction (i.e., transfer of one or more electrons from a reducing agent), reductive dissociation of the O—O bond, and coordination of a mono- or dinuclear oxygen species to a metal center.

As used herein, the term “base polymer” is a polymer optionally having a gas transmission rate of a selected material that is substantially lower than, lower than or substantially equivalent to, that of the channeling agent. By way of example, such a transmission rate would be a transmission rate in embodiments where the selected material is moisture and the active agent is a water absorbing desiccant. The primary function of the base polymer is to provide structure or a blended form for the entrained polymer. Suitable base polymers include thermoplastic polymers, e.g., polyolefins such as polypropylene and polyethylene, polyisoprene, polybutadiene, polybutene, polysiloxane, polycarbonates, polyamides, ethylene-vinyl acetate copolymers, ethylene-methacrylate copolymer, poly(vinyl chloride), polystyrene, polyesters, polyanhydrides, polyacrylonitrile, polysulfones, polyacrylic ester, acrylic, polyurethane and polyacetal, or copolymers or mixtures thereof.

Referring to such a comparison of the base polymer and channeling agent transmission rates, in one embodiment, the channeling agent has a transmission rate of at least two times that of the base polymer. In another embodiment, the channeling agent has a transmission rate of at least five times that of the base polymer. In another embodiment, the channeling agent has a transmission rate of at least ten times that of the base polymer. In still another embodiment, the channeling agent has a transmission rate of at least twenty times that of the base polymer. In still another embodiment, the channeling agent has a transmission rate of at least fifty times that of the base polymer. In still another embodiment, the channeling agent has a transmission rate of at least one hundred times that of the base polymer.

As used herein, the term “channeling agent” or “channeling agents” is defined as a material that is immiscible with the base polymer and has an affinity to transport a gas phase substance at a faster rate than the base polymer. Optionally, a channeling agent is capable of forming channels through the entrained polymer when formed by mixing the channeling agent with the base polymer. Optionally, such channels are capable of transmitting a selected material through the entrained polymer at a faster rate than in solely the base polymer.

As used herein, the term “channels” or “interconnecting channels” is defined as passages formed of the channeling agent that penetrate through the base polymer and may be interconnected with each other.

As used herein, the term “entrained polymer” is defined as a monolithic material in a blended form, formed of at least a base polymer with an active agent and optionally also a channeling agent entrained or distributed throughout. An entrained polymer thus includes two-phase polymers and three phase polymers.

As used herein, the term “monolithic,” “monolithic structure” or “monolithic composition” is defined as a composition or material that does not consist of two or more discrete macroscopic layers or portions. Accordingly, a “monolithic composition” does not include a multi-layer composite (although it may be part of a multi-layer composite). A “monolithic composition” includes a blended form.

As used herein, the term “organic” refers to a compound that contains carbon. Organic compounds may therefore be a synthetic compound, a naturally occurring compound, or a chemically modified naturally occurring compound.

As used herein, the term “phase” is defined as a portion or component of a monolithic structure or composition that is uniformly distributed throughout, to give the structure or composition its monolithic characteristics.

As used herein, the term “selected material” is defined as a material that is acted upon by, or interacts or reacts with an active agent and is capable of being transmitted through the channels of an entrained polymer. For example, in embodiments in which a desiccant is used as an active agent, the selected material may be moisture or a gas that can be absorbed by the desiccant. In embodiments in which a releasing material is used as an active agent, the selected material may be an agent released by the releasing material, such as moisture, fragrance, or an antimicrobial agent. In embodiments in which an adsorbing material is used as an active agent, the selected material may be certain volatile organic compounds and the adsorbing material may be activated carbon.

Selected materials in the compositions disclosed herein include oxidizing agents, more particularly volatile or gaseous oxidizing agents, even more particularly oxygen.

As used herein, the term “three phase” is defined as a monolithic composition or structure comprising three or more phases. An example of a three phase composition according to the disclosure would be an entrained polymer formed of a blended form of a base polymer, active agent, and channeling agent. Optionally, a three phase composition or structure may include an additional phase, e.g., a colorant (thus “three phase” indicates at least three phases, including a base polymer, active agent and channeling agent).

Suitable channeling agents may include a polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent 35 can be, for example, a water insoluble polymer, such as a propylene oxide polymerisate-monobutyl ether, such as Polyglykol B01/240, produced by CLARIANT. In some embodiments, the channeling agent is a propylene oxide polymerisate monobutyl ether, such as Polyglykol B01/20, produced by CLARIANT, propylene oxide polymerisate, such as Polyglykol D01/240, produced by CLARIANT, ethylene vinyl acetate (EVA), nylon 6, nylon 66, or any combination of the foregoing.

In some embodiments, the base polymer ranges from 10% to 90% by weight of the total composition, optionally from 20% to 80% by weight. When an optional channeling agent is employed, the channeling agent may be provided in a range of 2% to 15% by weight, optionally 2% to 10%, optionally about 5%.

It is believed that the higher the active agent concentration in the mixture, the greater the absorption, adsorption or releasing capacity (as the case may be) will be of the final composition. However, too high an active agent concentration could cause the entrained polymer to be more brittle and the molten mixture of active agent, base polymer and channeling agent to be more difficult to process. In one embodiment, the active agent loading level can range from 10% to 80%, optionally 35% to 70%, optionally from 40% to 60%, optionally from 45% to 55% by weight with respect to the total weight of the entrained polymer.

Optionally, channeling agent may be provided in a range of 2% to 15% by weight, optionally 2-12%, optionally 5-12%, optionally about 10%, optionally about 9%, optionally about 8%, optionally about 7%, optionally about 6%, optionally about 5%, optionally about 4%, optionally about 3%, optionally about 2%. Optionally, the base polymer may range from 10% to 65% by weight of the total composition, optionally from 20% to 45% by weight, optionally from 25% to 35% by weight. Optionally, a colorant is added, e.g., at about 0.5-2% or at about 1% by weight of the total composition. Combination of any of the above ranges with respect to the base polymer, active agent, channeling agent, and colorant is contemplated.

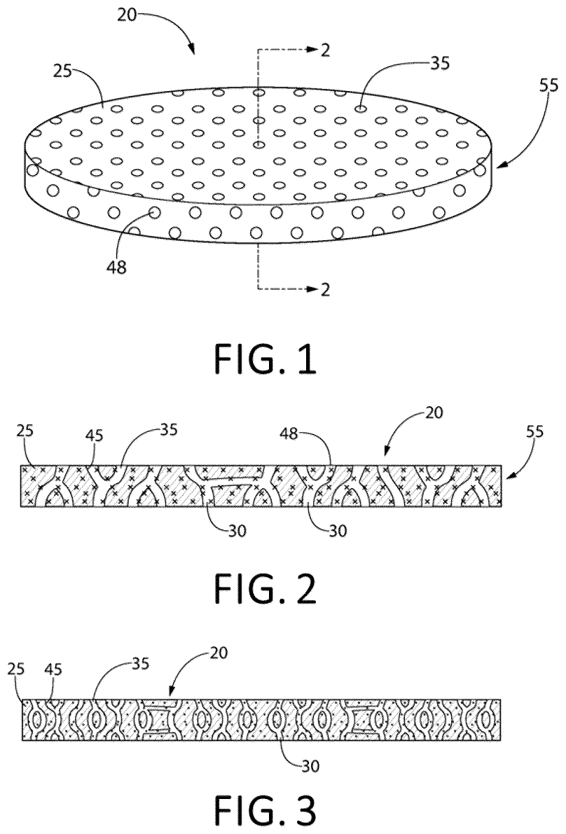

FIGS. 1-6 illustrate entrained polymers 20 and various packaging assemblies formed of entrained polymers according to certain embodiments of the disclosure. The entrained polymers 20 each include a base polymer 25, optionally a channeling agent 35 and an active agent 30. As shown, the channeling agent 35 forms interconnecting channels 45 through the entrained polymer 20. At least some of the active agent 30 is contained within these channels 45, such that the channels 45 communicate between the active agent 30 and the exterior of the entrained polymer 20 via channel openings 48 formed at outer surfaces of the entrained polymer 25. The active agent 30 can be, for example, any one of a variety of releasing materials, as described in further detail below. While a channeling agent, e.g., 35, is preferred, the disclosure broadly includes entrained polymers that optionally do not include a channeling agent.

FIG. 1 shows a plug 55 constructed of an entrained polymer 20, in accordance with certain embodiments of the invention. The plug 55 may be placed inside of a container. As aforementioned, the entrained polymer 20 includes a base polymer 25, a channeling agent 35 and an active agent 30.

FIG. 2 shows a cross-sectional view of the plug 55 shown in FIG. 1. In addition, FIG. 2 shows that the entrained polymer 20 has been solidified such that the channeling agent 35 forms interconnecting channels 45 to establish passages throughout the solidified plug 55. At least some of the active agent 30 is contained within the channels 45, such that the channels 45 communicate between the active agent 30 and the exterior of the entrained polymer 20 via channel openings 48 formed at outer surfaces of the entrained polymer 25.

FIG. 3 illustrates an embodiment of a plug 55 having similar construction and makeup to the plug 55 of FIG. 2, where interconnecting channels 45 are finer as compared to those shown in FIG. 2. This can result from the use of a dimer agent (i.e., a plasticizer) together with a channeling agent 35. The dimer agent may enhance the compatibility between the base polymer 25 and the channeling agent 35. This enhanced compatibility is facilitated by a lower viscosity of the blend, which may promote a more thorough blending of the base polymer 25 and channeling agent 35, which under normal conditions can resist combination into a uniform solution. Upon solidification of the entrained polymer 20 having a dimer agent added thereto, the interconnecting channels 45 which are formed there-through have a greater dispersion and a smaller porosity, thereby establishing a greater density of interconnecting channels throughout the plug 55.

Interconnecting channels 45, such as those disclosed herein, facilitate transmission of a desired material, such as moisture, gas or odor, through the base polymer 25, which generally acts as a barrier to resist permeation of these materials. For this reason, the base polymer 25 itself acts as a barrier substance within which an active agent 30 may be entrained. The interconnecting channels 45 formed of the channeling agent 35 provide pathways for the desired material to move through the entrained polymer 10. Without these interconnecting channels 45, it is believed that relatively small quantities of the desired material would be transmitted through the base polymer 25 to or from the active agent 30. Additionally, wherein the desired material is transmitted from the active agent 30, it may be released from the active agent 30, for example in embodiments in which the active agent 30 is a releasing material, such as an antimicrobial gas releasing material.

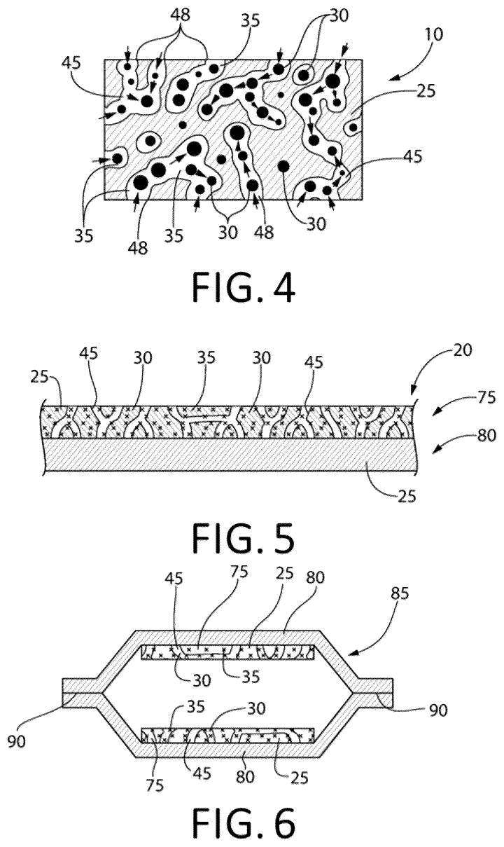

FIG. 4 illustrates an embodiment of an entrained polymer 10 according to the disclosure. The arrows indicate the path of a selected material, for example oxygen, from an exterior of the entrained polymer 10, through the channels 45, to the grains or particles of active agent 30.

FIG. 5 illustrates an active sheet or film 75 formed of the entrained polymer 20 used in combination with a barrier sheet 80 to form a composite, according to an aspect of the invention. The characteristics of the active sheet or film 75 are similar to those described with respect to the plug 55. The barrier sheet 80 may be a substrate such as foil and/or a polymer with low moisture or oxygen permeability. The barrier sheet 80 is compatible with the entrained polymer structure 75 and is thus configured to thermally bond to the active sheet or film 75, when the active sheet or film 75 solidifies after dispensing.

FIG. 6 illustrates an embodiment in which the active sheet or film 75 and the barrier sheet 80 are combined to form a packaging wrap having active characteristics at an interior surface formed by the entrained polymer 20 in the active sheet or film 75, and vapor resistant characteristics at an exterior surface formed by the barrier sheet 80. In this embodiment, the active sheet or film 75 occupies a portion of the barrier sheet 80. The methods according to the invention for making the active sheet or film 75 and adhering it to the barrier sheet 80 are particularly limited.

In one embodiment, the sheets of FIG. 5 are joined together to form an active package 85, as shown in FIG. 6. As shown, two laminates or composites are provided, each formed of an active sheet or film 75 joined with a barrier sheet 80. The sheet laminates are stacked, with the active sheet or film 75 facing one another, so as to be disposed on an interior of the package, and are joined at a sealing region 90, formed about a perimeter of the sealed region of the package interior.

In some embodiments, the entrained polymer is positioned in a container and substantially all of the interior-facing part of the container is composed of the entrained polymer. In some embodiments, the container is fabricated so that the entrained polymer is located below the level of a liquid medium contained in the package, thereby providing direct contact between the active agent and the liquid medium.

Optionally, in any embodiment, the aforementioned extrusion process includes coextrusion of two or more layers wherein at least one such layer is the active layer (mixture of polymer and active agent) and at least another such layer is a polymer material without an active agent incorporated therein. In such embodiments, what may be formed is a multilayer composite in which at least one layer is an active entrained polymer layer.

Various aspects of the disclosure will be illustrated in more detail with reference to the following Examples, but it should be understood that the present disclosure is not deemed to be limited thereto.

### Example 1. Measurement of Oxygen Concentration

Non-invasive Oxysense® OxyDot oxygen sensors are employed to measure oxygen concentrations. The OxyDot sensor contains a fluorescent dye whose fluorescence lifetime and emission intensity are correlated with oxygen concentration. To determine oxygen concentration, an OxyDot sensor is attached to the inside of a container having a headspace therein. The sensor is illuminated with a pulsed blue light from an LED. The blue light is absorbed by the sensor and red light is emitted. The red light is detected by a photo-detector and the characteristics of the fluorescence lifetime are measured. One or more calibration curves are constructed from standard samples with known concentrations of oxygen to identify the correlation between fluorescence lifetime and oxygen concentration. From the calibration curves and fluorescence emission data, the concentration of oxygen in a headspace can be found.

### Example 2. Oxygen Decrease with Lycopene Powders

Preliminary studies used 1.0 gram, 2.0 gram, and 3.0 gram quantities of lycopene powder. The powder was chosen from sources having lycopene purities of 5%, 10%, and 96%. The sample of lycopene powder was placed in a glass jar with an OxyDot sensor. Unless indicated otherwise, n=3, i.e., 3 vials were prepared for each quantity of lycopene powder. Samples were periodically tested using the OxyDot procedure of Example 1 over a span of about 30 days.

### 5% Lycopene Powder

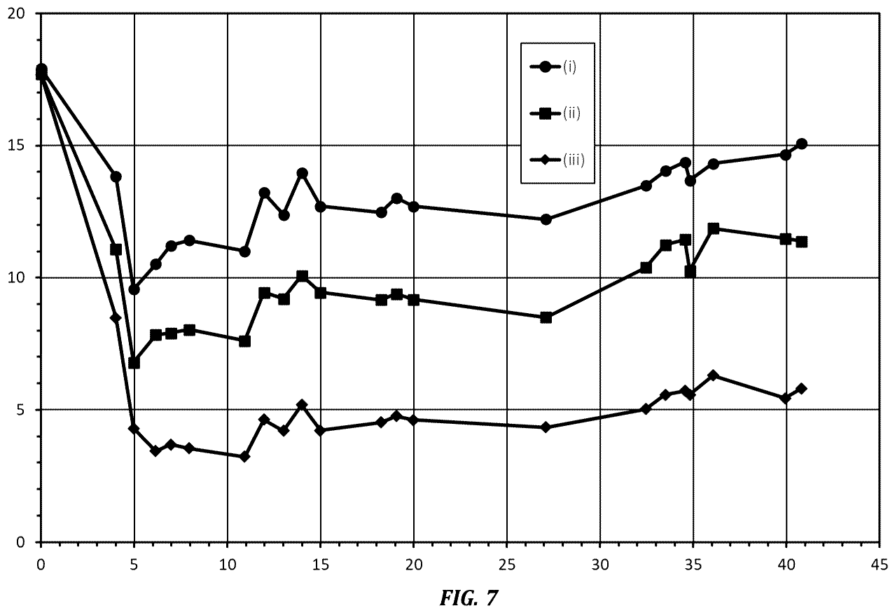

Samples were prepared containing 1.0 gram, 2.0 gram, and 3.0 gram quantities of 5% lycopene powder (n=15) and tested using the OxyDot procedure of Example 1. Data for oxygen decrease experiments are depicted in FIG. 7 and are provided in Table 2. For each amount, oxygen decreased from initial conditions over an initial period of about 5 days. This initial period was followed by a period of stable, or slightly rising, concentrations of oxygen. Minimum oxygen concentrations for the 1 gram, 2 gram, and 3 gram samples were about 10%, 7%, and 4%, respectively.

TABLE 2
Decrease in oxygen concentration by 5% lycopene powder

| Time | Amt. Lycopene Powder | | |
|---|---|---|---|
| (days) | 1 gram | 2 grams | 3 grams |
| 0.00 | 17.92 | 17.70 | 17.68 |
| 4.00 | 13.83 | 11.07 | 8.49 |
| 4.96 | 9.56 | 6.79 | 4.31 |
| 6.16 | 10.52 | 7.84 | 3.44 |
| 6.95 | 11.22 | 7.91 | 3.69 |
| 7.93 | 11.41 | 8.03 | 3.55 |
| 10.92 | 11.00 | 7.62 | 3.23 |
| 11.95 | 13.22 | 9.44 | 4.63 |
| 13.01 | 12.39 | 9.21 | 4.21 |
| 13.98 | 13.98 | 10.08 | 5.19 |
| 14.99 | 12.71 | 9.44 | 4.23 |
| 18.24 | 12.48 | 9.16 | 4.53 |
| 19.07 | 13.02 | 9.39 | 4.76 |
| 19.97 | 12.71 | 9.17 | 4.62 |
| 27.09 | 12.22 | 8.51 | 4.35 |
| 32.43 | 13.49 | 10.38 | 5.04 |
| 33.49 | 14.05 | 11.24 | 5.57 |
| 34.56 | 14.37 | 11.45 | 5.72 |
| 34.82 | 13.68 | 10.27 | 5.58 |
| 36.04 | 14.31 | 11.87 | 6.31 |
| 39.92 | 14.67 | 11.49 | 5.44 |
| 40.81 | 15.08 | 11.38 | 5.81 |

### 10% Lycopene Powder

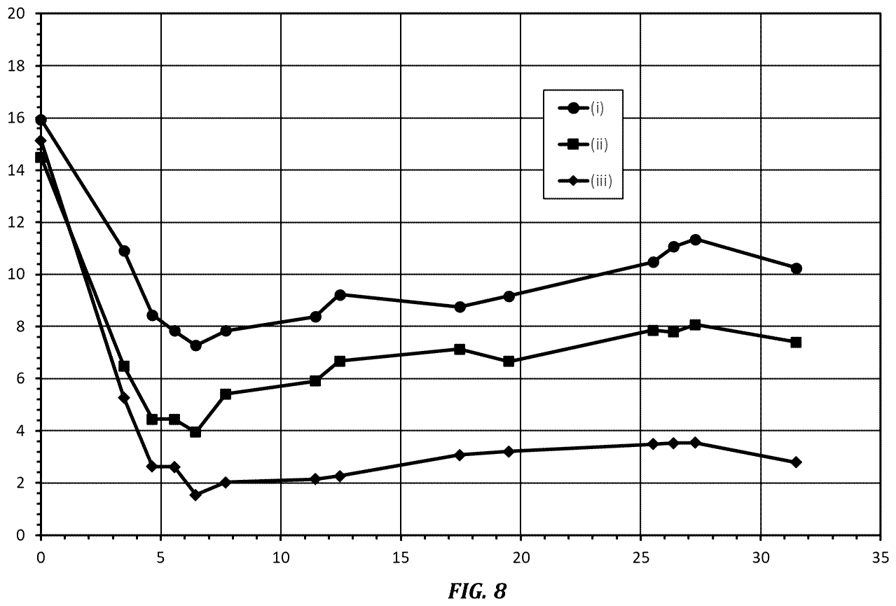

Samples were prepared containing 1.0 gram, 2.0 gram, and 3.0 gram quantities of 10% lycopene powder and tested using the OxyDot procedure of Example 1. For each quantity, 3 vials were prepared. Data for oxygen decrease experiments are depicted in FIG. 8 and are provided in Table 3. As with the samples containing 500 lycopene powder, oxygen content decreased over an initial period of about 5 days, followed by a period of stable, or slightly rising, concentrations of oxygen. Minimum oxygen concentrations were, in each case, lower than comparable samples containing 500 lycopene. Minimum oxygen concentrations for the 1 gram, 2 gram, and 3 gram samples were about 800, 400 and 20%, respectively.)

TABLE 3
Decrease in oxygen concentration by 10% lycopene powder

| Time | Amt. Lycopene Powder | | |
|---|---|---|---|
| (Days) | 1 gram | 2 grams | 3 grams |
| 0.00 | 15.95 | 14.50 | 15.14 |
| 3.46 | 10.93 | 6.49 | 5.28 |
| 4.63 | 8.45 | 4.45 | 2.63 |
| 5.56 | 7.84 | 4.45 | 2.61 |
| 6.46 | 7.28 | 3.95 | 1.54 |
| 7.70 | 7.85 | 5.42 | 2.02 |
| 11.42 | 8.38 | 5.92 | 2.15 |
| 12.45 | 9.23 | 6.67 | 2.27 |
| 17.45 | 8.76 | 7.13 | 3.07 |
| 19.50 | 9.18 | 6.66 | 3.21 |
| 25.51 | 10.48 | 7.86 | 3.49 |
| 26.38 | 11.07 | 7.79 | 3.53 |
| 27.27 | 11.35 | 8.08 | 3.55 |
| 31.47 | 10.24 | 7.40 | 2.80 |

### 96% Lycopene Powder

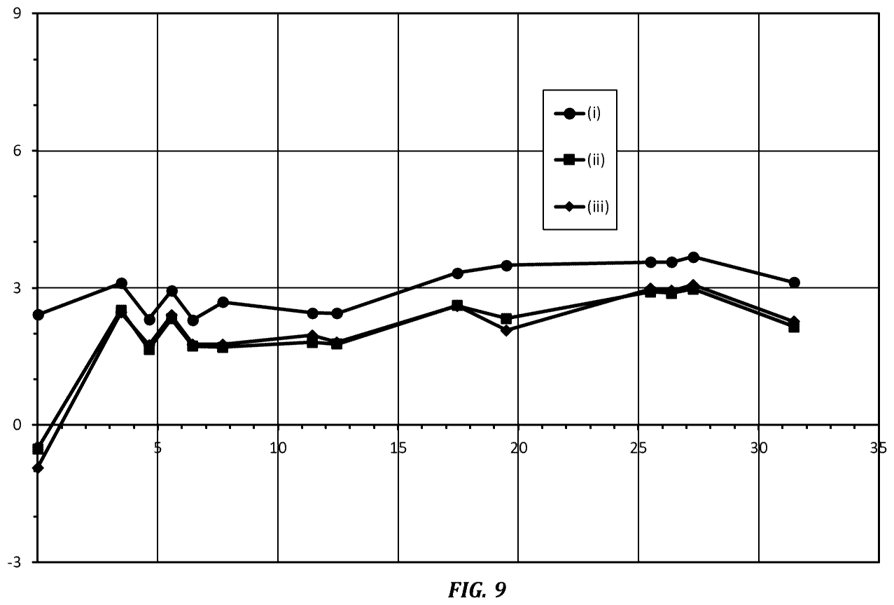

Samples were prepared containing 1.0 gram, 2.0 gram, and 3.0 gram quantities of 96% lycopene powder. For each quantity, 3 vials were prepared. Data for oxygen decrease experiments are depicted in FIG. 9 and are provided in Table 4. For each sample, oxygen concentrations rapidly dropped to 20% or below, and stabilized between 20% and 4%. In each case, after about 2 days, oxygen concentrations had dropped to below 20%.

TABLE 4
Decrease in oxygen concentration by 96% lycopene powder. I.

| Time | Amt. Lycopene Powder | | |
|---|---|---|---|
| (Days) | 1 gram | 2 grams | 3 grams |
| 0.00 | 2.42 | −0.52 | −0.93 |
| 3.46 | 3.10 | 2.51 | 2.47 |
| 4.63 | 2.32 | 1.66 | 1.75 |
| 5.56 | 2.94 | 2.32 | 2.40 |
| 6.46 | 2.30 | 1.73 | 1.76 |
| 7.70 | 2.69 | 1.71 | 1.76 |
| 11.42 | 2.45 | 1.81 | 1.96 |
| 12.45 | 2.45 | 1.77 | 1.81 |
| 17.45 | 3.33 | 2.61 | 2.61 |
| 19.50 | 3.50 | 2.33 | 2.07 |
| 25.51 | 3.56 | 2.92 | 2.98 |
| 26.38 | 3.56 | 2.88 | 2.94 |
| 27.27 | 3.68 | 2.97 | 3.07 |
| 31.47 | 3.12 | 2.15 | 2.26 |

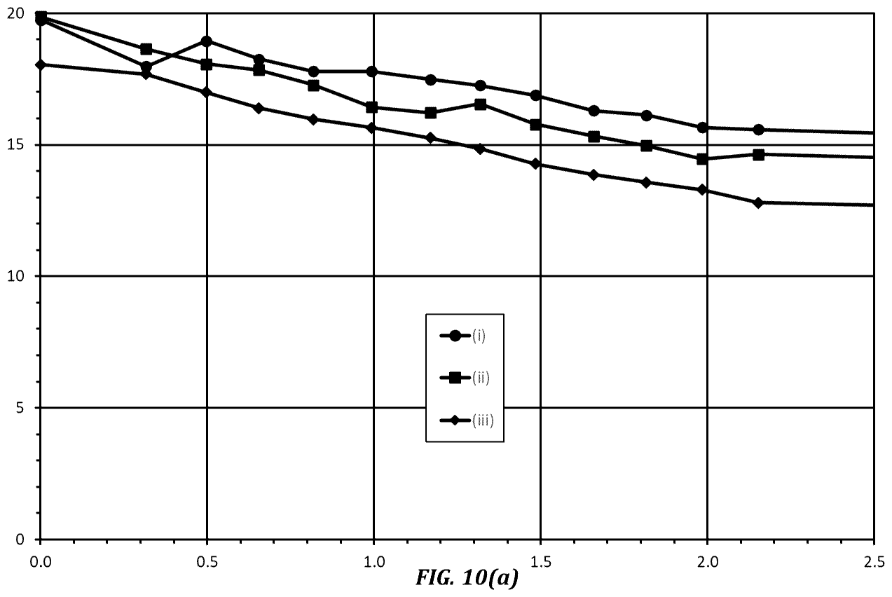

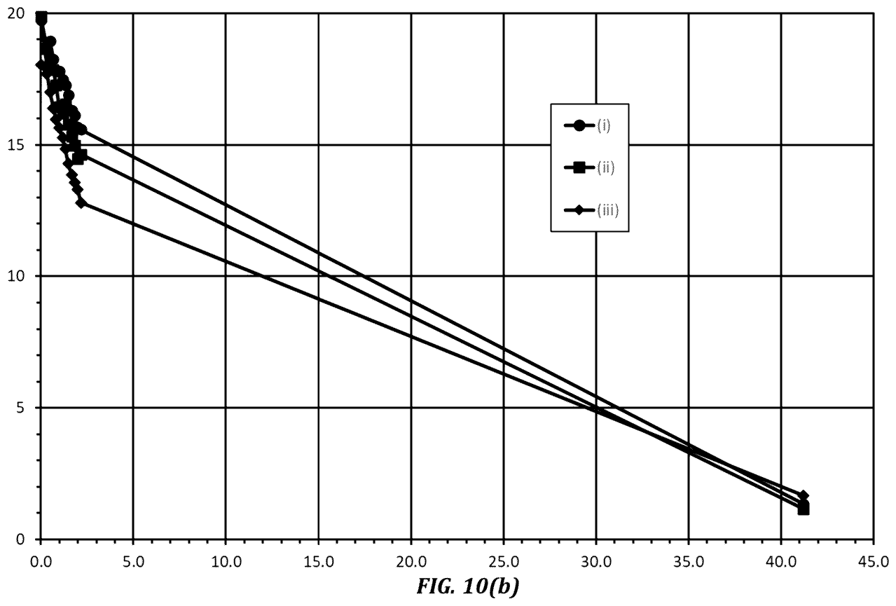

Experiments directed to measuring the initial period of oxygen decrease were conducted with samples containing 960 lycopene powder. Vials containing 1.0 gram, 2.0 gram, and 3.0 gram quantities of 96% lycopene (n=3) were prepared and tested about every 10 minutes for 2 hours, and again after 48 hours, using the OxyDot procedure of Example 1. Data are depicted in FIG. 10(a) and FIG. 10(b) and are provided in Table 5. For each sample, oxygen concentrations rapidly dropped to between 13% and 16% over 2 hr.

TABLE 5
Decrease in oxygen concentration by 96% lycopene powder. II.

| | | |
|---|---|---|
| Time | Time | Amt. Lycopene Powder |

| (Hours) | (Mins) | 1 gram | 2 grams | 3 grams |
|---|---|---|---|---|
| 0.00 | 0.00 | 19.75 | 19.87 | 18.05 |
| 0.32 | 18 | 17.97 | 18.64 | 17.69 |
| 0.50 | 29 | 18.95 | 18.07 | 17.00 |
| 0.65 | 39 | 18.26 | 17.85 | 16.39 |
| 0.82 | 49 | 17.79 | 17.27 | 15.96 |
| 0.99 | 59 | 17.79 | 16.43 | 15.65 |
| 1.17 | 70 | 17.49 | 16.21 | 15.27 |
| 1.32 | 79 | 17.26 | 16.55 | 14.84 |
| 1.48 | 89 | 16.89 | 15.78 | 14.28 |
| 1.66 | 99 | 16.30 | 15.32 | 13.87 |
| 1.82 | 108 | 16.12 | 14.97 | 13.58 |
| 1.98 | 119 | 15.67 | 14.46 | 13.29 |
| 2.15 | 129 | 15.58 | 14.63 | 12.80 |
| 41.19 | 2471 | 1.35 | 1.17 | 1.68 |

### 96% Lycopene Powder: Reduced Quantities

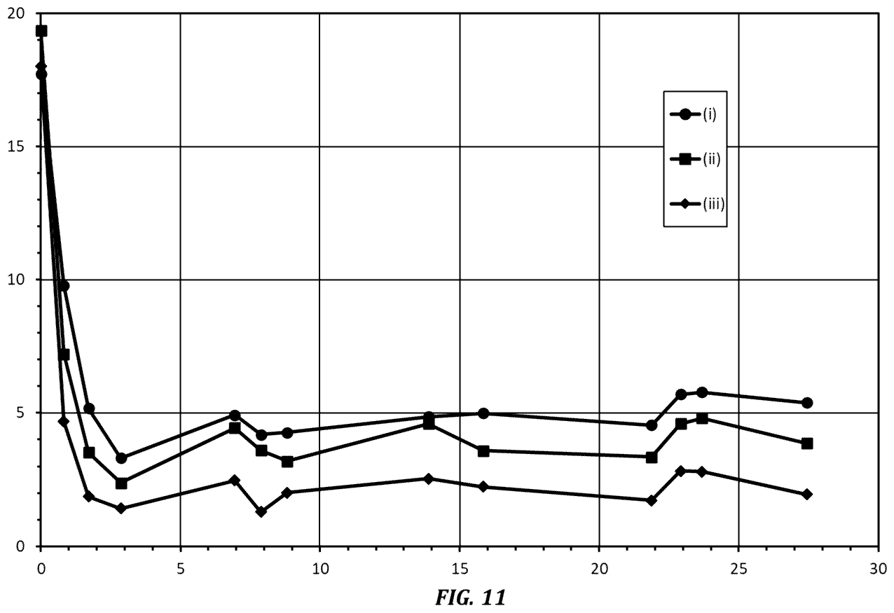

Experiments were then conducted using reduced quantities of lycopene powder. Samples containing 0.25-0.75 grams of 96% lycopene (n=3) were tested using the OxyDot procedure of Example 1. Data are depicted in FIG. 11 and are provided in Table 6. After 27 days, oxygen content had decreased to about 500 or less.

TABLE 6
Decrease in oxygen concentration by reduced
quantities of 96% lycopene powder

| | |
|---|---|
| Time | Amt. Lycopene Powder |

| (Days) | 0.25 grams | 0.50 grams | 0.75 grams |
|---|---|---|---|
| 0.00 | 17.73 | 19.36 | 18.02 |
| 0.81 | 9.78 | 7.21 | 4.68 |
| 1.70 | 5.18 | 3.52 | 1.87 |
| 2.85 | 3.30 | 2.37 | 1.42 |
| 6.94 | 4.92 | 4.44 | 2.47 |
| 7.88 | 4.19 | 3.60 | 1.29 |
| 8.82 | 4.27 | 3.19 | 2.01 |
| 13.87 | 4.87 | 4.60 | 2.53 |
| 15.83 | 4.99 | 3.58 | 2.23 |
| 21.88 | 4.54 | 3.35 | 1.72 |
| 22.91 | 5.70 | 4.59 | 2.83 |
| 23.67 | 5.78 | 4.80 | 2.79 |
| 27.45 | 5.39 | 3.86 | 1.95 |

### Example 3. Oxygen Decrease with Lycopene-Containing Films

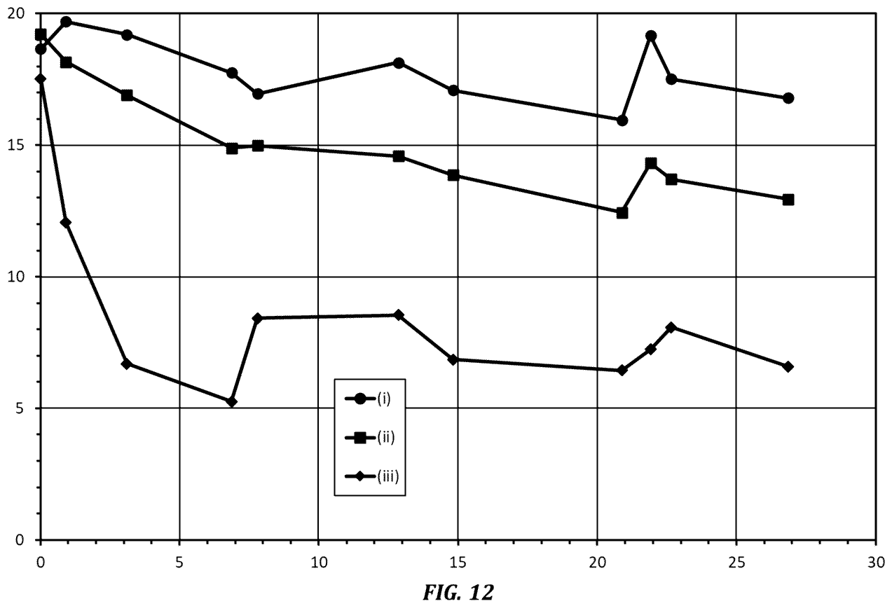

Lycopene powder was then used as an active component within an EVA based film. Lycopene films were developed using a conical twin-screw extruder. The film formulation consisted of 15% lycopene powder, containing 5%, 10%, or 96% lycopene (n=3), and 85% EVA, and was extruded at 180° C. Film samples with dimensions of 2 cm×2 cm were tested once a day for 30 days using the OxyDot procedure of Example 1. Data are depicted in FIG. 12 and are provided in Table 7.

In the presence of the film containing 96% lycopene powder, oxygen concentrations decreased to about 5% after 6 days, followed by 20 days between about 4% and 8%. Oxygen decrease with films containing either the 5% or the 10% lycopene was not as efficient. In the presence of the film containing 10% lycopene powder, oxygen concentrations decreased to about 14% oxygen over 26 days. In the presence of the film containing 5% lycopene powder, a barely perceptible decrease in oxygen concentrations could be observed.

TABLE 7
FIG. 12 data

| Time | Amt. Lycopene | | |
|---|---|---|---|
| (Days) | 5% | 10% | 96% |
| 0.00 | 18.66 | 19.23 | 17.53 |
| 0.91 | 19.70 | 18.17 | 12.05 |
| 3.10 | 19.20 | 16.90 | 6.69 |
| 6.87 | 17.76 | 14.90 | 5.26 |
| 7.79 | 16.96 | 14.98 | 8.43 |
| 12.85 | 18.14 | 14.59 | 8.55 |
| 14.81 | 17.09 | 13.87 | 6.85 |
| 20.88 | 15.96 | 12.45 | 6.44 |
| 21.91 | 19.17 | 14.32 | 7.25 |
| 22.65 | 17.52 | 13.70 | 8.08 |
| 26.84 | 16.80 | 12.95 | 6.58 |

While the disclosed concept has been described in detail and with reference to specific examples thereof, it will be apparent to one skilled in the art that various changes and modifications can be made therein without departing from the spirit and scope thereof.

What is claimed is:

1. An entrained polymer comprising, in a blended form:
a base polymer; and
lycopene, or a derivative thereof, optionally wherein the lycopene, or derivative thereof, is a granular or particulate material.

2. The entrained polymer of claim 1, wherein the base polymer is chosen from a polyolefin, polyamide and a polyester.

3. The entrained polymer of claim 2, wherein the base polymer is a polyester.

4. The entrained polymer of claim 2, wherein the base polymer is a polyolefin.

5. The entrained polymer of claim 4, wherein the polyolefin has formula (—CH₂CHR—)ₙ, wherein R is chosen from H and C₁₋₁₀alkyl.

6. The entrained polymer of claim 4, wherein the polyolefin is chosen from polyethylene, polypropylene, and a polyethylene/polypropylene copolymer.

7. The entrained polymer of claim 1, wherein the base polymer is a copolymer.

8. The entrained polymer of claim 7, wherein the base polymer is a copolymer with an alpha olefin having formula H₂C═CHR, wherein R is chosen from H and C₁₋₁₀alkyl.

9. The entrained polymer of claim 8, wherein the base polymer is a copolymer with ethylene.

10. The entrained polymer of claim 8, wherein the base polymer is ethylene vinyl acetate.

11. The entrained polymer of claim 1, wherein the base polymer is a block copolymer.

12. The entrained polymer of claim 11, wherein the block copolymer comprises a polyester segment and a polyether segment.

13. The entrained polymer of claim 12, wherein the polyester segment is poly(alkylene terephthalate).

14. The entrained polymer of claim 13, wherein the polyether segment is a poly(alkylene glycol).

15. The entrained polymer of claim 1, further comprising a channeling agent.

16. The entrained polymer of claim 15, wherein the amount of channeling agent in the entrained polymer is in a range from 1% to 25%, optionally from 2% to 15%, optionally from 5% to 20%, optionally from 8% to 15%, optionally from 10% to 20%, optionally from 10% to 15%, optionally from 10% to 12%, optionally from 5% to 15%, optionally about 7% by weight of the total weight of the polymer composition.

17. The entrained polymer of claim 15, wherein the channeling agent is chosen from polyethylene glycol (PEG), ethylene-vinyl alcohol, polyvinyl alcohol, glycerin polyamine, polyurethane, polycarboxylic acid, propylene oxide polymerisate-monobutyl ether, propylene oxide polymerisate, ethylene vinyl acetate, nylon 6, nylon 66, and combinations thereof.

18. The entrained polymer of claim 1, wherein the lycopene is an alcohol, aldehyde, or carboxylic acid derivative of lycopene.

19. The entrained polymer of claim 1, wherein the lycopene, or derivative thereof, comprises 5% to 50%, optionally 5% to 30%, optionally from 5% to 25%, optionally from 10% to 20%, optionally from 12% to 16% by weight with respect to the total weight of the entrained polymer.

20. A method for manufacturing the entrained polymer of claim 1, comprising the steps of:
extruding a suitable precursor material comprising a molten mix of a polymer and lycopene, or a derivative thereof in a screw extruder with warming;
passing the warmed extruded material through a tubular die;
expanding and stretching the warmed extruded material with positive pressure; and
allowing the expanded and stretched extruded material to cool.

21. A container comprising:
the entrained polymer of claim 1; and
an interior space suitable for storage.
